(19) United States
(12) Patent Application Publication
(10) Pub. No.: US 2012/0281391 A1
(43) Pub. Date: Nov. 8, 2012

(54) SOLAR-POWERED SWOOPER/BANNER FLAGPOLE

(76) Inventor: BRUCE FRANK BORT, Lemont, IL (US)

(21) Appl. No.: 13/462,475

(22) Filed: May 2, 2012

Related U.S. Application Data
(60) Provisional application No. 61/518,403, filed on May 5, 2011.

(51) Int. Cl. F21L 4/02; F21L 4/08

(52) U.S. Cl. 362/183

(57) ABSTRACT

A hollow metal/plastic swooper/banner flagpole having holes spaced along the length of the flagpole. Light fixtures and reflectors are inserted inside the pole to direct light outward through the holes. The flagpole is intended to be placed on a base/stand and able to spin with the lights directed to illuminate the inside of a flag or banner.

This application claims priority from previously filed provisional application filed on May 5, 2011 and assigned Ser. No. 61/518,403. This invention relates to a Solar-Powered Swooper/Banner Flagpole that illuminates flags and banners at night for a highly visible and very appealing look.

### BACKGROUND OF INVENTION

Sports fans, business owners, governments, and others use swooper/banner flags and flagpoles to show team pride, advertising products and brands or promoting fairs, holidays, special events, etc. Having lights inside or attached to the flagpole illuminates the flags and/or banners which draws attention and allows them to be seen at night. The invention allows for an energy efficient and inexpensive way of illuminating flags and banners. The way the flags and banners are placed over the solar-powered swooper/banner flagpoles allows very little to no light pollution, just an appealing visual of an illuminated flag or banner. Another benefit is that they can be changed easily. This is ideal for companies that change advertising campaigns often, and for seasonal/holiday decorating and sports that change throughout the year.

### BRIEF DESCRIPTION OF THIS INVENTION

The invention is a Solar-Powered Swooper/Banner Flagpole that consists of a rotating solar unit attached to a swooper/banner flagpole. The solar unit contains the batteries, switches and PCB board. On the outside of the solar unit are solar panels/solar energy collectors on all sides of the unit so when the flags or banners move in the wind and turn the swooper/banner flagpole, there is always a sufficient amount of solar panels/solar energy collectors facing the sun to charge the rechargeable batteries. The number of sides with solar panels/solar energy collectors depends on the size (length and width) of the solar panel, but the solar panels must go all the way around the unit. The pole/frame sections of the swooper/banner flagpole contain LED lights inside or attached to them. There are wires that connect the LED lights from one section to the next section of the swooper/banner flagpole and to the batteries/switches/PCB board in the rotating solar unit.

### BRIEF DESCRIPTION OF DRAWINGS

FIG. 1 shows two sections of a Solar-Powered Swooper/Banner Flagpole.

FIG. 2 shows the inside of a section of a solar flagpole and two views of a connector.

FIG. 3 shows a section of a swooper/banner flagpole and a strip of plastic made for attaching the LED lights to the inside of the flagpole.

FIG. 4 shows a section of a swooper/banner flagpole with stick-on LED lights that come on a roll and have adhesive on them like a roll of tape.

FIG. 5 shows a swooper/banner flagpole with a swooper/banner flag on it.

FIG. 6 shows a solar-powered swooper/banner flagpole assembled and displaying a flag/banner.

FIG. 7 shows a solar swooper/banner flagpole on a swooper flagpole spike/base with a four-legged stabilizing support stand.

FIG. 8 shows three views of a rotating solar unit (top, bottom, side).

FIG. 9 shows a plastic spacer for keeping a space in between the two faces of a flag or banner.

FIG. 10 shows a side view of a section of a solar-powered swooper/banner flagpole with a plastic spacer.

FIG. 11 shows a front view of a section of a solar-powered swooper/banner flagpole.

FIG. 12 shows a flag or banner with snaps.

FIG. 13 shows a solar-powered swooper/banner flagpole with a frame that goes all the way around the inside of the flag/banner and a flag/banner with two faces made to slide over the flag/banner flagpole.

FIG. 14 shows a flag/banner flagpole with a rotating solar unit and is wall-mounted.

FIG. 15 shows a bottom of a flag/banner flagpole with a wall-mounted base.

FIG. 16 shows a wall-mount base for a solar flagpole.

FIG. 17 shows the corner of a wall-mounted solar flagpole with a flagpole topper that can be illuminated and match/complement the theme of the flag or banner.

### DETAILED DESCRIPTION OF THIS INVENTION

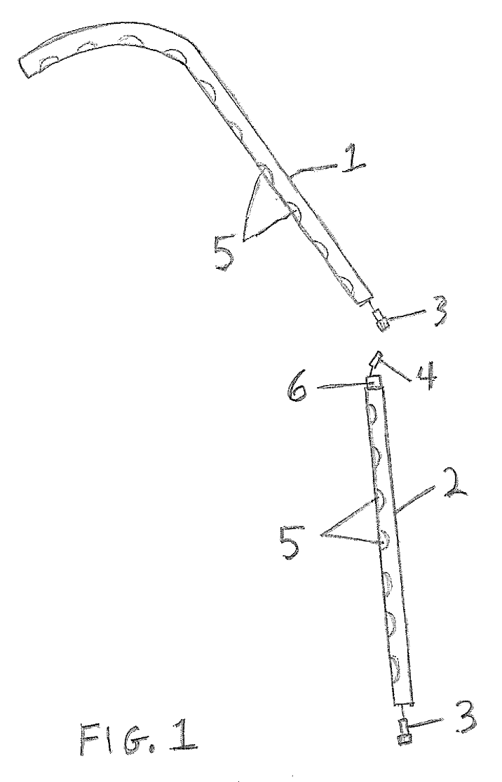

FIG. 1 shows #1 the top section of a solar-powered swooper/banner flagpole. #2 shows the next section of a solar-powered swooper/banner flagpole. #3 is a female connector end of the wire that connects to #4 a male end that connects the wires that go to the LED lights and connects to the rotating solar unit and batteries. #5 shows the holes in the swooper/banner flagpole where the LED lights shine through. #6 is a coupling that connects the sections of a swooper/banner flagpole together. The swooper/banner flagpole can be made of aluminum, plastic, fiberglass or clear plastic. If clear plastic is used for the frame/sections of the solar-powered swooper/banner flagpole, holes are not needed since it is transparent.

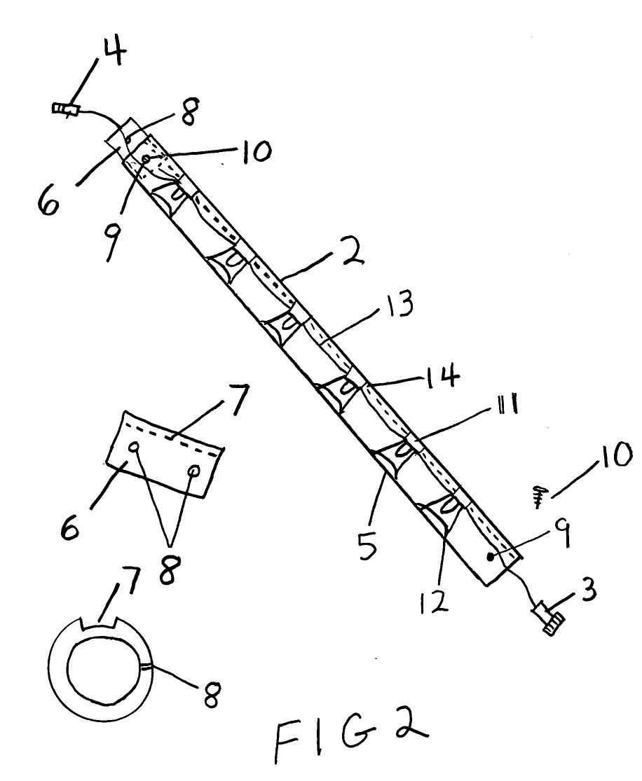

FIG. 2 shows #6 a coupling with a groove #7 that is made to receive a strip #14 that has the LED lights attached to it, and is attached to the inside section of the swooper/banner flagpole. #8 shows the screw holes that have screws #10 that pass through #9 holes in the swooper/banner flagpole sections and connect the swooper/banner flagpole together. #11 is an LED light which is attached to #14. #12 is a reflector that is attached to #11. They (#11 and #12) can be glued or snapped together or can come manufactured together for attaching to #14 which can have #11 glued or snapped to #14. #13 shows wires that connect the LED lights and the two screws on connectors #3 and #4 at the two ends of the swooper/banner flagpole section #2.

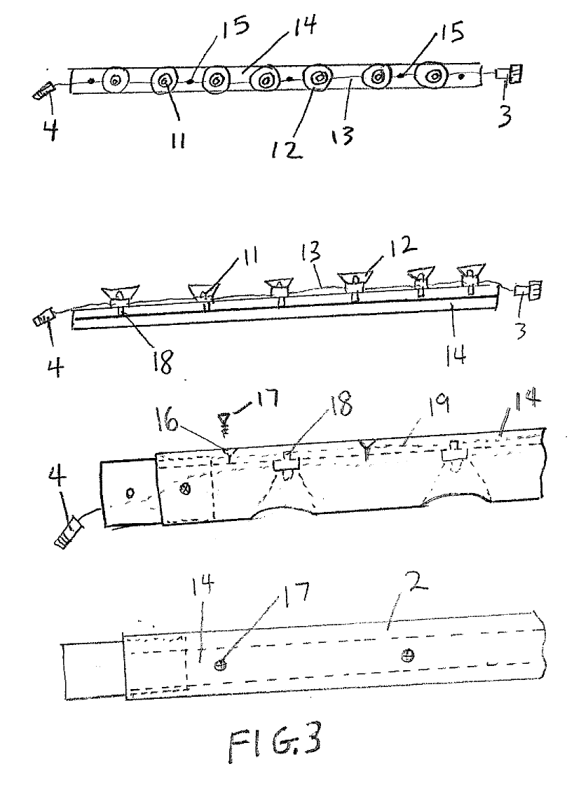

FIG. 3 shows #14 the strip for attaching the LED lights in a top view, a side view, and two views of it inside #2. #14 can be made of plastic or other lightweight material. #15 shows holes drilled through #14 to receive screws #17 that go through holes #16 and attached to #2 a section of the swooper/banner flagpole to attach the LED lights and reflectors to the inside of the swooper/banner flagpole. Glue could also be used for attaching the LED light strip #14 to the inside of #2. #18 shows a clip on the LED base that can snap onto a groove #19 in the side on #14 for attaching the LED lights and reflectors.

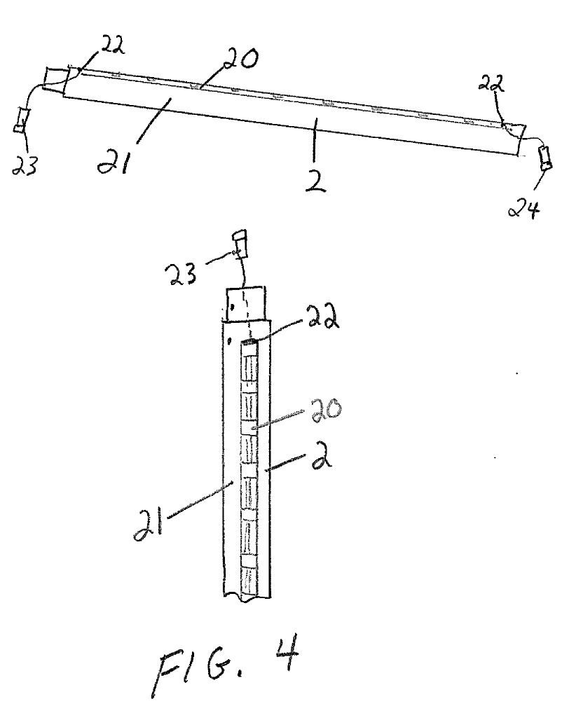

Referring to FIG. 4, #20 shows LED lights that come on a roll (like tape) with adhesive on the back for attaching to other material. See #20 attached to #2 and see #22 a hole where the plug ends of #20 the LED tape/adhesive strip goes into the inside of #2 and the female clip #23 and the male clip #24 come out at the ends of the swooper/banner flagpole section so when they are connected and the swooper/banner flagpole sections are connected, they are protected from being pulled apart or damaged. #21 shows a clear plastic film/shrink wrap that can be put over #2 to secure the attachment of #20 (LED tape) and seal the holes #22. The plastic film/shrink wrap can be heated for a tight seal. This method of sealing could be used with the other type of LED light insertion into the flagpole as shown in FIG. 2 and FIG. 3.

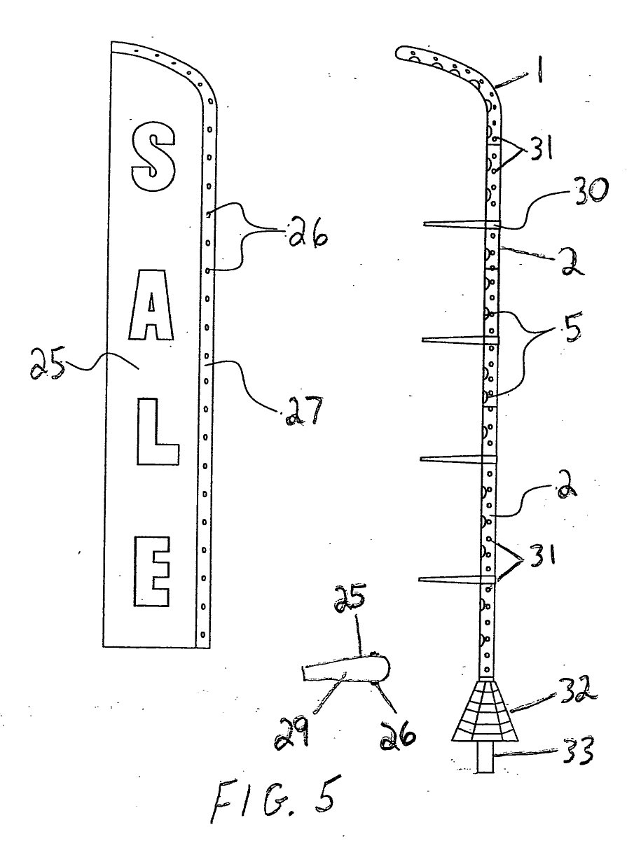

Referring to FIG. 5, #25 is a swooper/banner flag that has female snaps #26 that are attached to #27 the border/edge of the swooper/banner flag which is made to slip over a swooper/banner flagpole and snap onto #31 the male snaps running the length of the swooper/banner flagpole. #29 shows the bottom opening of #25 where it slips over the swooper/banner flagpole. #30 is a spacer made to keep a space inside the swooper/banner flag for illumination. #32 is a rotating solar unit attached to the bottom section of a swooper/banner flagpole.

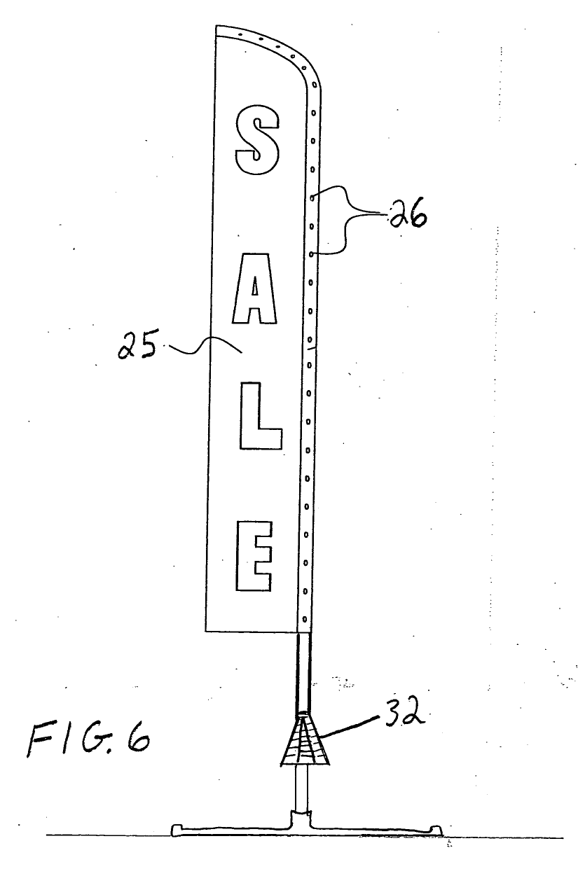

FIG. 6 shows #25 a swooper/banner flag snapped and displayed on a fully assembled solar-powered swooper/banner flagpole.

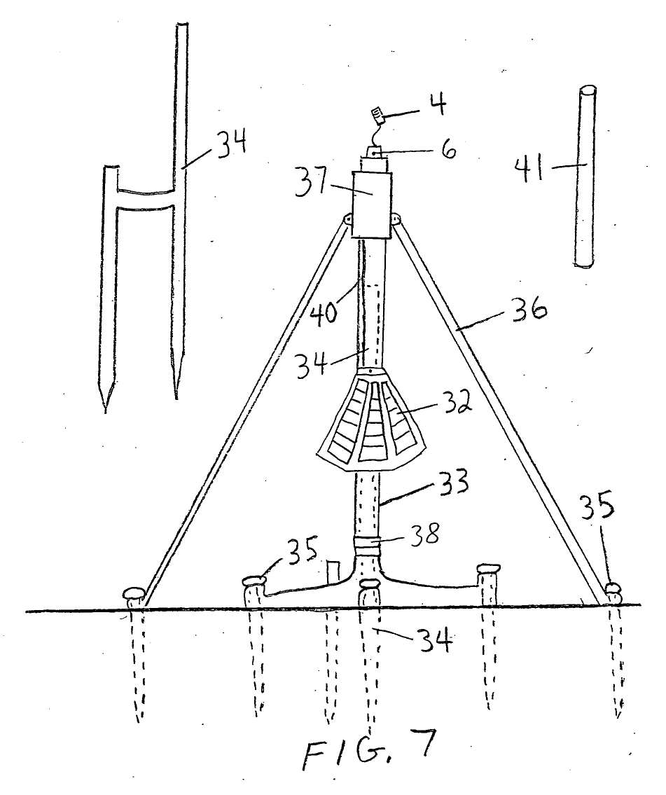

Referring to FIG. 7, #34 shows a common two-prong spike for a swooper/banner flagpole. #39 shows a four-legged base stand that slips over #34 to help stabilize and secure it in place in the ground. #37 shows a sleeve that slips over #33 the bottom section of a solar-powered swooper/banner flagpole. #37 can have bearings in it with the inside being the race side. #36 shows one of the four legs that attach with screws or rivots to the outside of #37 and are secured to the ground with #35 ground spikes. #38 is a bearing sleeve with #33 resting on the top of #38 which is the race end of #38, allowing #33 to spin freely. When referring to #37 and #38, they could be made with or without bearings. #38 could be replaced by just a couple of smooth washers. #40 is the wire that comes out of the rotating solar unit #32 which goes on the outside of #33 until it gets near the top and passes where #34 reaches inside of #33. Then #40 goes inside of #33 and through #6 the connector at the top end of #33 and is attached to #4 the male wire connector that attaches the LED lights to the rest of the solar-powered swooper/banner flagpole. #41 is a thin sleeve that can go over #33 and #40 from the top of #32 the solar unit until a short distance past where #40 goes back into #33 so that #41 can protect #40. Another option would be that #40 could have a thin plastic tube that goes over it for protection. There are many types of base/stands on the market that could work with a solar-powered swooper/banner flagpole. Since solar-powered swooper/banner flagpoles have slight extra weight, some stands and bases may need to be a bit larger or reinforced with a four-legged support stand/sleeve. See #37 and #36. A minimum diameter of a solar-powered swooper/banner flagpole should be approximately 2 inches, for which some stands may require an additional sleeve or to be made slightly larger.

FIG. 8 shows a side view, top view and bottom view of #32 a rotating solar unit, #42 shows the opening/hole that #33 is slid into and secured with #44 small screws or rivots. Glue could also be used for attaching. #43 shows the solar panels. #45 shows the hole that #40 comes out of the solar unit. #46 shows a switch for length of time lights stay on. #47 is a switch for mode (flashing, chasing, etc.). #48 is an on/off switch, but the solar unit could have the lights go on automatically at night. #49 shows the frame of a rotating solar unit that could be made of molded plastic specifically for holding and insertion of the components of the unit (solar panel, switches, PCB board, batteries and wires) which can be held in place by snaps, glue, screws, rivots or other commonly used manufacturing methods. #50 shows screws that hold #52 the bottom plate of the solar unit in place and attached to #49. #51 shows covers for accessing and replacing batteries.

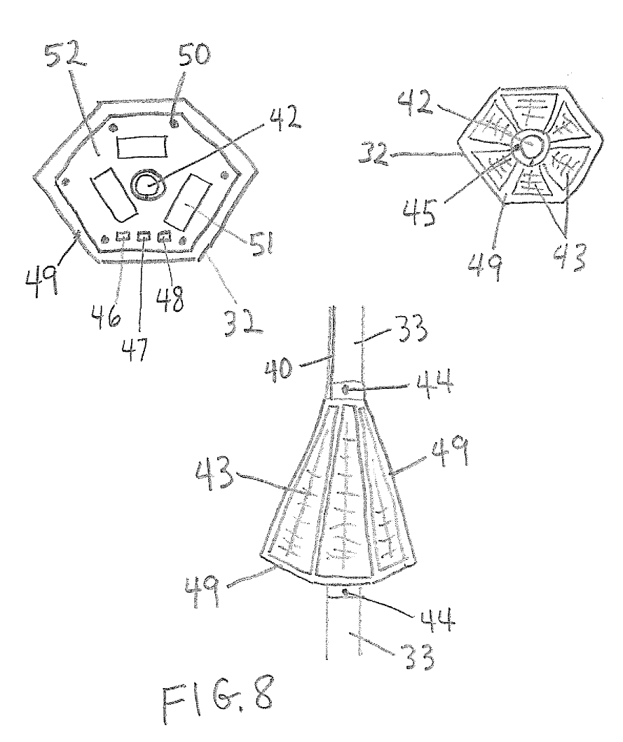

Referring to FIG. 9, #30 is a plastic spacer for keeping a space inside a banner or flag for illumination. #53 shows a screw and hole for attaching #30 to the sections of a solar-powered swooper/banner flagpole.

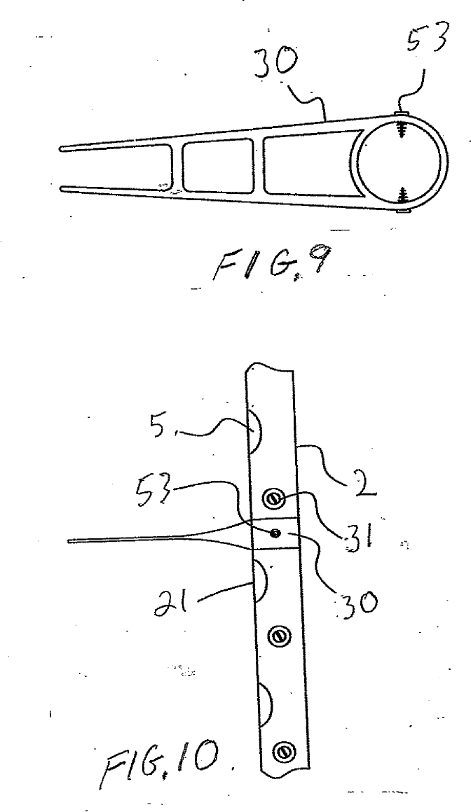

FIG. 10 shows a side view of #2 a section of a solar-powered swooper/banner flagpole with #30 attached with #53 the screw and #31 a male snap attached also with a screw. #21 shows plastic film/shrink wrap attached to cover the outside of the flagpole.

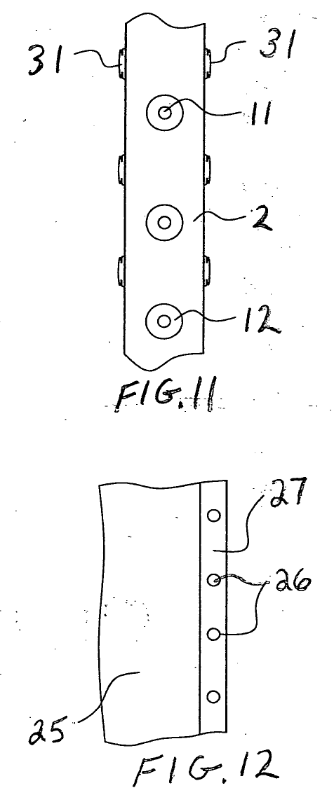

FIG. 11 shows a front view of #2 a section of a solar-powered swooper/banner flagpole with #11 and #12 LED lights and reflectors directed outward toward where a banner or flag are secured for illumination.

FIG. 12 shows #25 a side view of a banner/flag with #27 the border and #26 the female snaps.

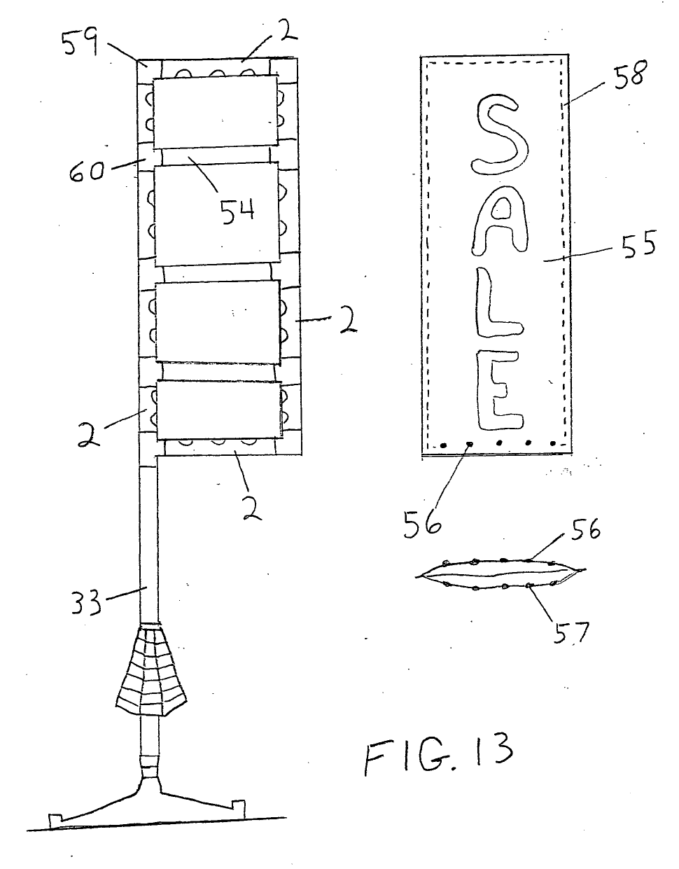

FIG. 13 shows a solar-powered swooper/banner flagpole with a frame connecting sections #2 on four sides with the use #59 corner couplings and #60 T-couplings. #54 shows clear thin plastic tubes being used for spacers. They go into #60 and keep the space inside #55 a banner/flag. #58 shows stitching for attaching two banners or flags together for sliding over a solar-powered swooper/banner flagpole. #56 are male snaps. #57 are female snaps. Snapping #56 and #57 together secures the banner/flag on the solar-powered swooper/banner flagpole. Using 8 mil. or 13 mil. commonly used polyethelene or vinyl banner material with the inside or back of it being high gloss white enhances the reflectability and illumination. The banners/flags can be made of commonly used materials such as polyethelene, vinyl, nylon, cotton, polyester, etc. They all must be somewhat or very translucent.

FIG. 14 shows a solar-powered swooper/banner flagpole that is wall-mounted or horizontally displayed. It is made using #59 and #60 to attach the #2 sections together. #54 is a thin clear spacer for keeping space inside the banner/flag. The snaps on a banner or flag can be put on different sides to accommodate the style of solar-powered swooper/banner flagpole. #61 is a corner coupling with #63 a flagpole attached/screwed on. #61 would be similar to #59 but have a male screw end or a small piece made to receive #63. #62 is a screw that goes through #33 and into a slot/groove in #64 the base for wall mounting or horizontal mounting. As with all solar products, having them in an area that gets plenty of sun is necessary. Walls facing north in the US may not work well.

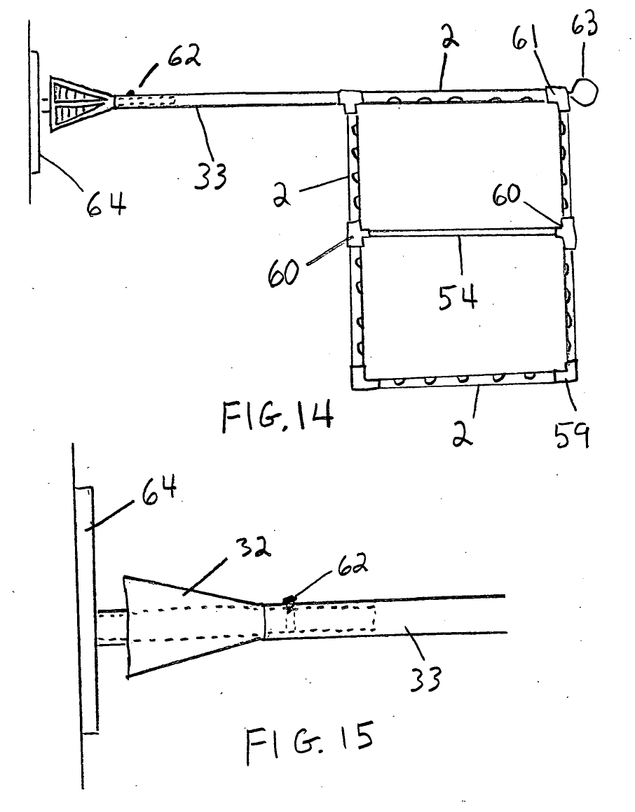

FIG. 15 shows a close-up view of a solar-powered swooper/banner flagpole on #64 a base with #62 holding it from sliding off.

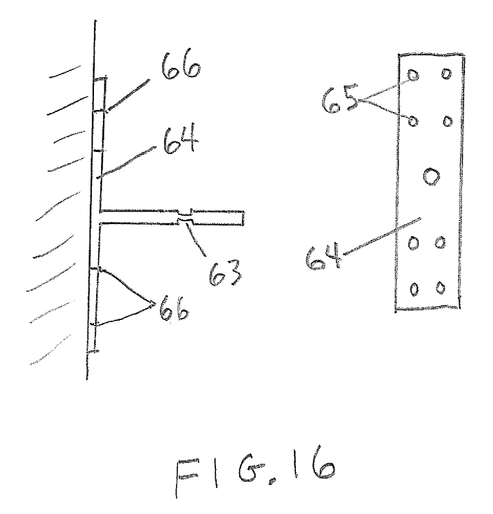

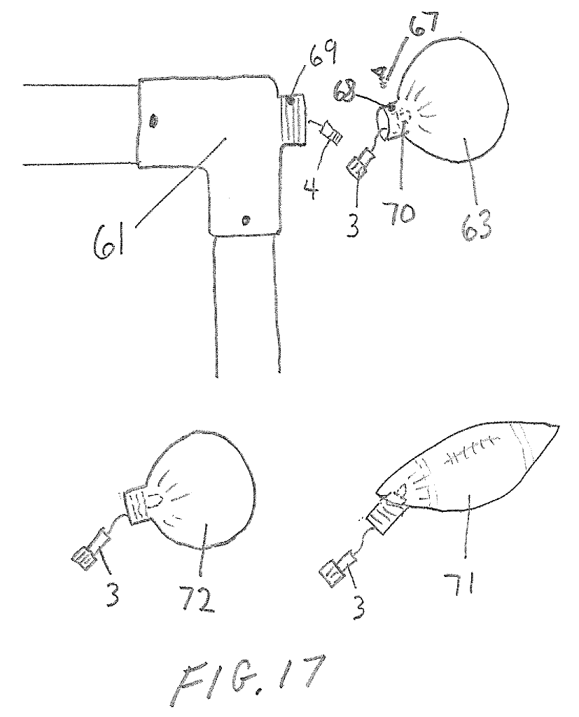

FIG. 16 shows a side view and a front view of #64 a wall-mounted/horizontal mount for a solar-powered swooper/banner flagpole. #63 is a slot/groove that #62 goes in, but #62 is made to still allow the solar-powered swooper/banner flagpole the ability to spin on #64 the base. #65 shows holes in #64 for attaching to a wall or post. #66 shows screws that attach #64 to a wall.

FIG. 17 shows #63 a flagpole topper that can be made of translucent plastic and have #70 and LED lights inside for illuminating it. #63 can attach by screwing it onto #61 and held in place with #67 a screw that goes through #68 a hole in #63 and into #69 a hole in #61. #4 a male wire connector and #3 a female wire connector connects #70 to the solar unit. #71 shows a translucent football that can be attached to #61. #72 shows a translucent ball that could be made to look like a sports ball of different types by changing its color/s. The toppers could have a large variety of shapes and themes to complement or enhance a banner or flag being displayed.

While the present invention has been described with respect to several different styles or options, it will be appreciated that many modifications and variations may be made without departing from the spirit and scope of the invention. It is, therefore, the intent of the appended claims to cover all such modifications and variations which fall within the spirit and scope of the invention.

What is claimed:

1. A flagpole made of hollow tubular sections. The upper sections have LED lights in them. There are holes in the upper sections where the lights are positioned. The upper sections connect to one another and to the top end of the bottom section. The bottom section has a solar unit attached to it with solar panels going 360 degrees around the outside of the solar unit. The solar unit contains rechargeable batteries, switch, and PCB board inside the solar unit. The solar panels collect solar energy and recharge the batteries, and the batteries illuminate the LED lights

2. The flagpole in claim 1 and a plastic spacer made to attach to the flagpole to keep a space inside a box flag/banner for illumination.

3. The flagpole in claim 1 with a frame of tubular sections with LED lights inside them and having them connected in a rectangular shape with the LED lights in the top vertical section and the lights in the bottom vertical section facing one another, and the LED lights in the two horizontal frame sections facing one another.

4. The flagpole in claim 3 and a clear plastic tube passing through the inside area of the flagpole frame and connected to the frame on its ends. The clear plastic tube keeps a space in between the box flag/banner.

5. Flagpole in claim 1 and having the top sections that contain the LED lights being made of a clear plastic tube/tubing.

6. Flagpole in claim 1 and the application of a LED light strip with adhesive on the back and applied to the top sections (without holes) of the flagpole.

7. Flagpole in claim 3 and being wall mounted or horizontally mounted and secured with a wall mount made with a rod for receiving or having the bottom section of the flagpole slipped over it. The wall mount has a slot/groove for securing the flagpole with a screw.

8. Flagpole in claim 1 and a flagpole topper that is made to be translucent and has a light inside it for illumination. The light is connected to the solar unit which illuminates it. The topper is made to be attached on the corner end of a flagpole.

9. Flagpole in claim 1 and a bearing sleeve that is slid over a flagpole, spike, or base and the flagpole rests on it, and the bearings allow the flagpole to spin easily.

10. Flagpole in claim 1 and a bottom section with a bearing sleeve attached to the very bottom, allowing the flagpole to spin easily.

11. A rotating solar unit, a cone shaped solar unit, or solar unit with solar panels/solar energy collectors going 360 degrees around the unit that contains batteries and PCB board and can be attached to a pole or rod/shaft by allowing them to pass through a hole or opening in the center of the rotating solar unit. The unit can be attached to the pole and if the pole spins, it will still collect solar energy and charge the batteries and the charged batteries can be used for powering a device or product needing a battery to operate or power it.
